(19) United States
(12) Patent Application Publication
(10) Pub. No.: US 2026/0147169 A1
(43) Pub. Date: May 28, 2026

(54) HIGH MIS-ALIGNMENT TOLERATE CO-PACKAGE OPTICS

(71) Applicant: International Business Machines Corporation, Armonk, NY (US)

(72) Inventors: Neng Liu, Albany, NY (US); Hsianghan Hsu, Latham, NY (US); Qianwen Chen, Fort Collins, CO (US); John Knickerbocker, Monroe, NY (US)

(21) Appl. No.: 18/956,122

(22) Filed: Nov. 22, 2024

(51) Int. Cl. G02B 6/42; G02B 6/293

(52) U.S. Cl. CPC G02B 6/4215; G02B 6/29328; G02B 6/4206

(57) ABSTRACT

A co-package optics structure is provided including a channel waveguide located in a glass substrate in which gradient period grating structures are located around the waveguide. Notably, the gradient period grating structures are located above, below and adjacent to each side of the waveguide. The waveguide and the gradient period grating structures are formed in the glass substrate using a laser which causes a change of the refractive index of the glass substrate in the areas in which laser exposure occurs.

### BACKGROUND

The present application relates to semiconductor technology, and more particularly to a co-package optics structure including a channel waveguide located in a glass substrate in which gradient period grating structures are located around the waveguide.

Communication systems and data centers are required to handle massive data at ever increasing speeds and ever decreasing costs. To meet these demands, optical fibers and optical integrated circuits (ICs), such as, for example, a photonic integrated circuits or integrated optical circuits, are used together with high speed electronic ICs. Such structures can be referred to herein as a co-package optics (CPO) structure (or assembly). CPO structures are aimed at addressing the next generation bandwidth and power challenges. CPO technology brings together a wide range of expertise in fiber optics, digital signal processing (DSP), switch ASICs, and state-of-the-art packaging and test to provide disruptive system value for the data center and cloud infrastructure.

### SUMMARY

A co-package optics structure is provided including a channel waveguide (hereinafter “waveguide”) located in a glass substrate in which gradient period grating structures are located around the waveguide. Typically, the gradient period grating structures are located above, below and adjacent to each side of the waveguide. The presence of the gradient period grating structures around the waveguide increases the passive alignment of the waveguide, and facilitates an increase in the intensity of light that passes through the waveguide. The gradient period grating structures are especially useful in cases in which a connector element such as, for example, a fiber ferrule) attached to the glass substrate is mis-aligned relative to the position of the waveguide. The waveguide and the gradient period grating structures are formed in the glass substrate using a laser which causes a change of the refractive index of the glass substrate in the areas in which laser exposure occurs.

In one embodiment of the present application, a co-package optics structure is provided that includes a waveguide located in, and traversing an entire length of, a glass substrate, and gradient period grating structures located in the glass substrate in which the gradient period grating structures traverse along a length of the waveguide and are located around the waveguide.

In another aspect of the present application, a method of forming a structure (i.e., a co-package optics structure) is provided. In one embodiment, the method includes forming, using a first laser scanning process, a first row of gradient period grating structures in a glass substrate; forming, using a continuous laser process, a waveguide in the glass substrate and above the first row of gradient period grating structures; and forming, using a second laser scanning process, a second row of gradient period grating structures in the glass substrate and above the waveguide.

### BRIEF DESCRIPTION OF THE DRAWINGS

FIG. 1 is a cross sectional view of an exemplary co-package optics structure in accordance with the present application.

FIG. 2 is a cross sectional view of another exemplary co-package optics structure in accordance with the present application.

FIG. 3 is a cross sectional view along cute Y-Y illustrated in FIG. 1 or FIG. 2

FIG. 4 is a cross sectional view of an exemplary structure that can be employed in forming a co-package optics structure in accordance with the present application, the exemplary structure including a first row of gradient period grating structures located in a glass substrate.

FIG. 5 is a cross sectional view of the exemplary structure of FIG. 4 after forming a waveguide in the glass substrate and above the first row of gradient period grating structures.

FIG. 6 is a cross sectional view of the exemplary structure of FIG. 5 after forming a second of gradient period grating structures in the glass substrate and above the waveguide.

### DETAILED DESCRIPTION

The present application will now be described in greater detail by referring to the following discussion and drawings that accompany the present application. It is noted that the drawings of the present application are provided for illustrative purposes only and, as such, the drawings are not drawn to scale. It is also noted that like and corresponding elements are referred to by like reference numerals.

In the following description, numerous specific details are set forth, such as particular

structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

It will be understood that when an element as a layer, region or substrate is referred to

as being “on” or “over” another element, it can be directly on the other element or intervening elements may also be present. In contrast, when an element is referred to as being “directly on” or “directly over” another element, there are no intervening elements present. It will also be understood that when an element is referred to as being “beneath” or “under” another element, it can be directly beneath or under the other element, or intervening elements may be present. In contrast, when an element is referred to as being “directly beneath” or “directly under” another element, there are no intervening elements present.

The terms substantially, substantially similar, about, or any other term denoting functionally equivalent similarities refer to instances in which the difference in length, height, or orientation convey no practical difference between the definite recitation (e.g., the phrase sans the substantially similar term), and the substantially similar variations. In one embodiment, substantial (and its derivatives) denote a difference by a generally accepted engineering or manufacturing tolerance for similar devices, up to, for example, 10% deviation in value or 10° deviation in angle.

Glass platform co-package optics structures have been attracting intense interest from the semiconductor industry. The alignment accuracy between the fiber to waveguide in a fiber ferrule is very important. However, there is always mis-alignment tolerance in a fiber ferule attached to a co-package optics structure which can cause high insertion loss. The present application improves the mis-alignment tolerance in a fiber ferrule attached to a glass co-package options waveguide by using a laser to fabricate gradient period gratings around the waveguide. In the present application, a laser is used to form a waveguide in a glass substrate, and the laser is also used to fabricate gradient period gratings around the waveguide. The phrase “gradient period gratings” is used throughout the present application to denote assisted gratings that include groups of gradient structures that are present in a single row in which each gradient structure in a specific group of gradient structures is spaced apart by a constant pitch, and the constant pitch within each group of period grating structures increases from a first end of the waveguide to a second end of the waveguide. In the present application, the first end of the waveguide represents a starting point in which light enters the waveguide and the second end represents an end in which light exists the waveguide.

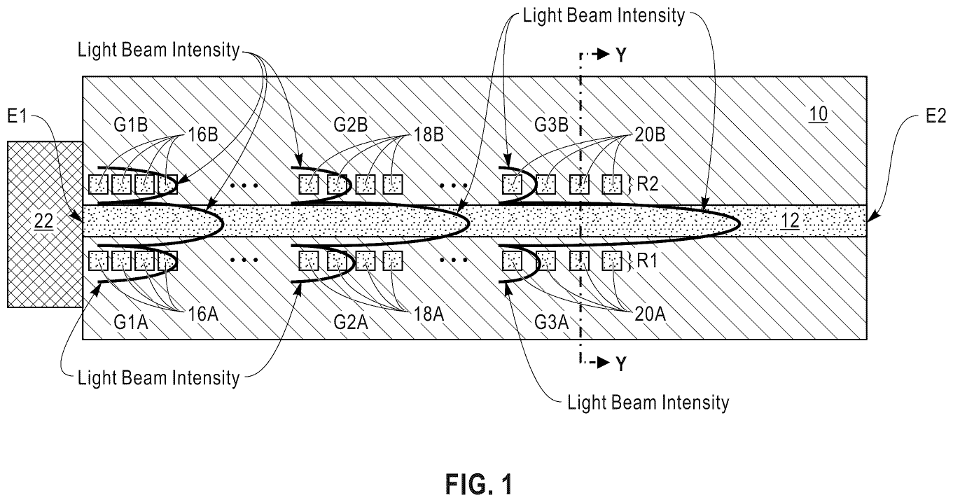

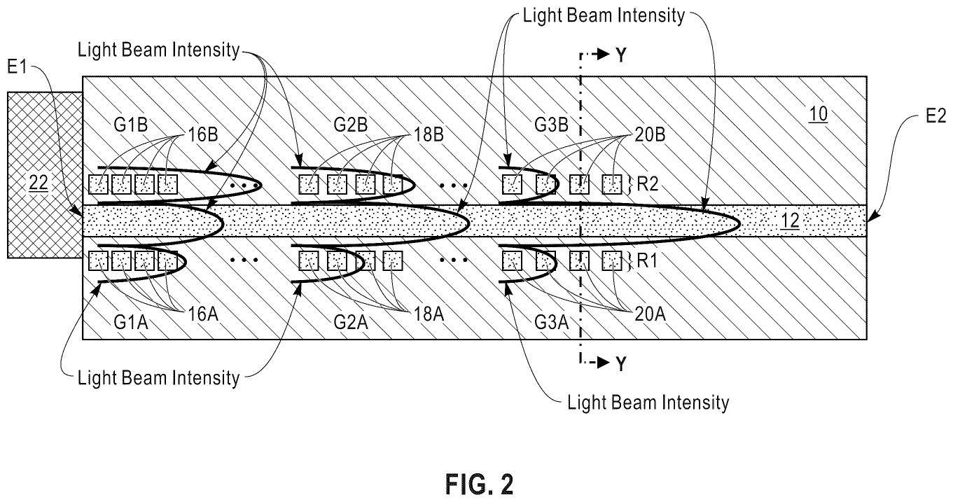

Notably, a co-package optics structure such as illustrated in FIGS. 1 and 2, is provided that includes a waveguide 12 located in, and traversing an entire length of, a glass substrate 10, and gradient period grating structures (e.g., period grating structures 16A, 18A and 20A within first row, R1, and period grating structures 16B, 18B and 20B within second row, R2) located in the glass substrate 10 in which the gradient period grating structures (e.g., period grating structures 16A, 18A and 20A within first row, R1, and period grating structures 16B, 18B and 20B within second row, R2) traverse along a length of the waveguide 12 and are located around the waveguide 12. The gradient period grating structures are used in the present application to reflect light that is not present in the waveguide 12 back into the waveguide 12 thus increasing the intensity of light that is transmitted through the waveguide 12.

In the present application, the glass substrate 10 has a first refractive index and the waveguide 12 has a second refractive index that is greater than the first refractive index. In some embodiments, the second refractive index can be 1 to 1.5 times greater than the first refractive index. In other embodiments, the second refractive index can be from 2 to 2.5 times greater than the first refractive index. In the present application, the glass substrate 10 is composed of any glass material in which a laser can be used to fabricate the waveguide 12 and the gradient period grating structures within the glass substrate 10. In some embodiments, glass substrate 10 is composed of an undoped glass material. In other embodiments, the glass substrate 10 is composed of a doped glass material. Specific examples of glass materials that can be used as the glass substrate 10 include, but are not limited to, fused silica, boro-aluminosilicate, soda lime, Er—Yb co-doped phosphate, Yb-doped phosphate, Yb-doped silicate or Yb doped borosilicate. It is noted that the waveguide 12 and each period grating structure is composed of a same glass material as the glass substrate 10 the difference being that the glass material that provides the waveguide 12 and each period grating structure has been structurally modified by laser exposure. This structure modification caused by laser exposure causes an increase the refractive index of the glass material that is exposed to the laser.

In the present application, the waveguide 12 and the gradient period grating structures are embed in the glass substrate 10. In the present application, and as illustrated in FIGS. 1 and 2, each gradient period grating structure is spaced apart from the waveguide 12 by a portion of the glass substrate 10.

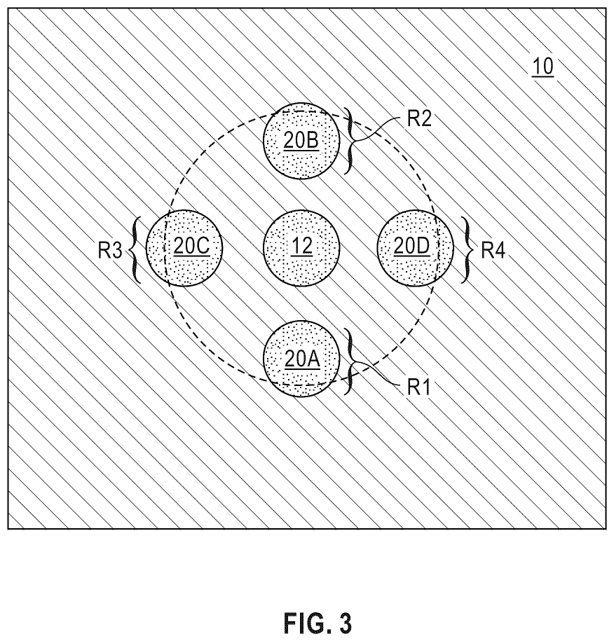

In the present application and as is illustrated in FIGS. 1 and 2, the waveguide 12 has a first end, E1, and a second end, E2, which is opposite the first end, E1. In the present application, the first end, E1, represents a starting point of the waveguide 12 in which light enters the waveguide 12 and the second end, E2, represents an end point of the waveguide 12 in which light exists the waveguide 12. The waveguide 12 of the present application can have various shapes. In one embodiment, which is apparent from the cross sectional view illustrated in FIG. 3, the waveguide 12 is cylindrical in shape. The length and diameter of the waveguide 12 can vary and are not critical aspects of the present application. The waveguide 12 is typically a single mode waveguide. By “single mode” it is meant that the waveguide 12 allows one type of colored light to pass through it.

As is illustrated in FIGS. 1 and 2, a fiber ferrule 22 is attached the glass substrate 10. Fiber ferrule 22 is used as a connecting element in an co-packing optics structure. While the present application, describes and illustrates fiber ferrule 22, other types of connecting elements that are well known to those skilled in the art can be attached to the glass substrate 10. The connecting elements including the fiber ferrule 22 is configured to transmit light into the waveguide 12. The connecting elements including the fiber ferrule 22 can be attached to the glass substrate 10 utilizing any attachment means including adhesive bonding.

In some embodiments of the present application, the fiber ferrule 22 (or other like connecting element) is substantially aligned to the waveguide 12. The term “substantially aligned” when referring to the fiber ferrule 22 (or other like connecting element) and the waveguide 12 denotes that a center (middle) portion of the fiber ferrule 22 (or other like connecting element) is located within 10% of a center (middle) portion of the waveguide 12. In other embodiments of the present application, the fiber ferrule 22 (or other like connecting element) is mis-aligned to the waveguide 12. The term “mis-aligned” when referring to the fiber ferrule 22 (or other like connecting element) and the waveguide 12 denotes that the center (middle) portion of the fiber ferrule 22 (or other like connecting element) is located greater than 10% from the center (middle) portion of the waveguide 12. In mis-aligned embodiments, there must be some degree of overlap between the fiber ferrule 22 (or other like connecting element) and the waveguide 12.

In the substantially aligned embodiments and as is illustrated in FIG. 1, the light beam

intensity is greatest within the waveguide 12 and less within the areas including the gradient period grating structures. In such embodiments, the presence of the gradient period grating structures can provide a slight improvement in the amount of light that passes through the waveguide 12. In mis-aligned embodiments, the light beam intensity is greatest outside the waveguide 12 in an area where the mis-alignment between the center portion of the fiber ferrule 22 (or other like connecting element) and the center portion of the waveguide 12 occurs. For example, and in the embodiment illustrated in FIG. 2, the center portion of the fiber ferrule 22 (or other like connecting element) is located above a center portion of the middle portion of the waveguide. In the illustrated embodiment shown in FIG. 2 and at the first end, E1, of the glass substrate 10, the light beam intensity is greatest in the areas including the second row, R2, of gradient period grating structures, less intense in the area including the waveguide 12 and even lesser intense in the area including the first row, R1, of gradient period grating structures. In such embodiments, the presence of the gradient period grating structures can provide a significant improvement in the amount of light intensity that passes through a remaining portion of the waveguide 12 by reflecting the light back into the waveguide 12.

In the present application, each of the gradient period grating structures has a refractive index that is greater than or equal to the second refractive index, but less than the first refractive index. Thus, the gradient period grating structures can reflect stay light (caused by any mis-aligned issues) back into the waveguide 12. In the present application, the gradient period grating structures include a plurality of groups of period grating structures, e.g., G1A, G2A and G3A in the first row, R1, and G1B, G2B and G3C in the second row, R2. In the present application, each period grating structure within a group of period grating structures is spaced apart by a constant pitch. The term “pitch” as used in the present application denotes a distance from one point of a period grating structure to the exact point of a nearest neighboring period grating structure within the group of gradient period grating structures. In the present application, the constant pitch within each group of period grating structures increases from the first end, E1, of the waveguide 12 to the second end, E2, of the waveguide 12. In the present application, and each group of period grating structures has an effective refractive index, R_{eff} that increases from the first end, E1, of the waveguide 12 to the second end, E2, of the waveguide 12. Thus, the co-package optics structure of the present application is designed to include gradient period grating structure having the highest effective refractive index at the first end, E1, of waveguide 12 so as to reflect stray light immediately back into the waveguide 12. The effective refractive index decreases as one moves from the first end, E1, of the waveguide 12 to the second end, E2, of the waveguide 12 since les stray light is present outside the waveguide 12 as moving from the first end, E1, to the second end, E2 of the waveguide 12. In some embodiments of the present application, each period grating structures has a cylinder shape as can be seen in FIG. 3.

For example, and in the embodiment illustrated in FIGS. 1 and 2, there is present of first row, R1, located beneath waveguide 12 that contains three groups of period grating structures. Notably, the first group, G1A, includes four first period grating structures 16A that are spaced apart by a first pitch (P1), the second group, G2A, includes four second period grating structures 18A that are spaced apart by a second pitch (P2), and the third group, G3A, includes four third period grating structures 20A that are spaced apart by a third pitch (P3) in which P1<P2<P3. In such an embodiment, G1A has a first effective refractive index (R1_{eff}), G2A has a second effective refractive index (R2_{eff}), and G3A has a third effective refractive index (R3_{eff}) in which R1_{eff}>R2_{eff}>R3_{eff}. The embodiment illustrated in FIGS. 1 and 2, also includes a second row, R2, above waveguide 12 that contains three groups of period grating structures. Notably, the first group, G1B, includes four first period grating structures 16B that are spaced apart by a first pitch (P1), the second group, G2B, includes four second period grating structures 18B that are spaced apart by a second pitch (P2), and the third group, G3B, includes four third period grating structures 20B that are spaced apart by a third pitch (P3) in which P1<P2<P3. In such an embodiment, G1B has a first effective refractive index (R1_{eff}), G2B has a second effective refractive index (R2_{eff}), and G3B has a third effective refractive index (R3_{eff}) in which R1_{eff}>R2_{eff}>R3_{eff}. It is noted that the number of groups within each row and the number of period grating structures within each group can vary from the number illustrated in FIGS. 1 and 2.

Although not illustrated in the cross sectional views depicted in FIGS. 1 and 2, there would be present a third row, R3, located on a first side of the waveguide 12 (e.g., inside the plane of the drawing sheet) that includes that includes the equivalent groups of period grating structures with an equivalent number of period grating structures having the same pitch and effective refractive index characteristics of the first and second groups of period grating structures, and a fourth row, R4, located on a second side of the waveguide 12 (e.g., in front of the plane of the drawing sheet) that includes that includes the equivalent groups of period grating structures with an equivalent number of period grating structures having the same pitch and effective refractive index characteristics of the first and second groups of period grating structures. This aspect is illustrated in FIG. 3 in which the third row, R3 including third period grating structure 20C and the fourth row, R4, including third period grating structure 20D is shown.

Although FIGS. 1 and 2 illustrates a single waveguide surrounded by gradient period grating structures, the present application contemplates embodiments when at least on additional waveguide is present. In such embodiments, each additional waveguide is designed to have gradient period grating structures (as defined herein) surrounding the additional waveguide.

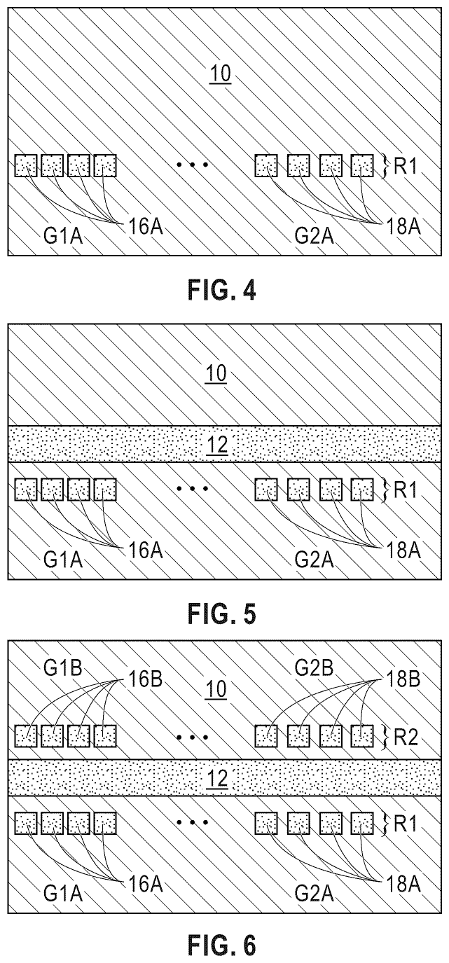

In another aspect of the present application, a method of forming a structure (i.e., a co-package optics structure) is provided. In one embodiment, the method includes forming, using a first laser scanning process, a first row, R1, of gradient period grating structures in glass substrate 10 (see, for example, FIG. 4); forming, using a continuous laser process, waveguide 12 in the glass substrate 10 and above the first row, R1, of gradient period grating structures (see, for example, FIG. 5); and forming, using a second laser scanning process, a second row, R2, of gradient period grating structures in the glass substrate 10 and above the waveguide 12 (see, for example, FIG. 6). In the exemplary embodiment illustrated in FIGS. 4-6), the first row, R1, includes a first group, G1A, including four first period grating structures 16A that are spaced apart by P1, a second group, G2A, including four second period grating structures 18A that are spaced apart by P2, and a third group, G3A, including four third period grating structures 20A that are spaced apart by P3, and the second row, R2, includes a first group, G1B, including four first period grating structures 16B that are spaced apart by P1, a second group, G2B, including four second period grating structures 18B that are spaced apart by P2, and a third group, G3B, including four third period grating structures 20C that are spaced apart by P3. A third row, R3 and a fourth row, R4, as defined above can also be formed on opposing sides of the waveguide 12 using a third laser scanning process and a fourth laser scanning process, respectively. It is noted that FIGS. 4-6, illustrates only a portion of the glass substrate 10.

Notably, FIG. 4 illustrates an exemplary structure that can be employed in forming a co-package optics structure in accordance with the present application. The exemplary structure illustrated in FIG. 4 includes first row, R1, of gradient period grating structures (as defined above) located in glass substrate 10. The first row, R1, of gradient period grating structures is formed using a first laser scanning process in which a laser is used in a pulsed mode (i.e., first laser scanning process) to cause structurally changes in the glass material that provides the glass substrate 10 in areas that are exposed to the laser pulse. Each structurally changed area represents a period grating structure. Any type of laser can be used during the first laser scanning process. The laser wavelength and outpower of the laser can vary depending on the type of laser employed as well as the composition of the glass substrate 10 that is used.

Referring now to FIG. 5, there is illustrated the exemplary structure of FIG. 4 after forming waveguide 12 in the glass substrate 10 and above the first row, R1, of gradient period grating structures. The waveguide 12 is formed using a continuous laser process in which a laser is used in a continuous mode to cause a continuous structural change in the glass material that provides the glass substrate 10 in areas that are exposed to the continuous laser exposure. The continuous laser process occurs through an entire length of the glass substrate 10. The continuous structurally changed area represents the waveguide 12. Any type of laser can be used during the continuous laser scanning. The laser wavelength and outpower of the laser can vary depending on the type of laser embodiment as well as the composition of the glass substrate 10 that is used.

Referring now to FIG. 6, there is illustrated the exemplary structure of FIG. 5 after forming a second row, R2, of gradient period grating structures (as defined above) in the glass substrate 10 and above the waveguide 12. The second row, R2, of gradient period grating structures is formed using a second laser scanning process in which a laser is used in a pulsed mode (i.e., second laser scanning process) to cause structurally changes in the glass material that provides the glass substrate 10 in areas that are exposed to the laser pulse. Each structurally changed area represents a period grating structure of the second row, R2. Any type of laser can be used during the first laser scanning process. The laser wavelength and outpower of the laser can vary depending on the type of laser employed as well as the composition of the glass substrate 10 being used.

The method also includes forming, using a third laser scanning process, third row, R3, of gradient period grating structures in the glass substrate 10 and adjacent a first side of waveguide 12; and forming, using a fourth laser scanning process, fourth row, R4. of gradient period grating structures in the glass substrate 10 and adjacent to a second side of the waveguide 12 in which the second side is opposite the first side. The third and fourth rows of gradient periodic gratings are not illustrated in the cross sectional views depicted in FIGS. 4-6. The laser used in the third and fourth laser scanning processes is used in a pulsed mode to cause structurally changes in the glass material that provides the glass substrate 10 in areas that are exposed to the laser pulse. Each structurally changed area represents a period grating structure of the third row, R3, and fourth row, R4. Any type of laser can be used during the third and fourth laser scanning processes. The laser wavelength and outpower of the laser can vary depending on the type of laser employed as well as the composition of the glass substrate 10 being used. It is noted that the continuous laser process, and each of the laser scanning processes increase a refractive index of the glass substrate that is subjected to laser exposure.

While the present application has been particularly shown and described with respect to preferred embodiments thereof, it will be understood by those skilled in the art that the foregoing and other changes in forms and details may be made without departing from the spirit and scope of the present application. It is therefore intended that the present application not be limited to the exact forms and details described and illustrated, but fall within the scope of the appended claims.

What is claimed is:

1. A co-package optics structure comprising:
a waveguide located in, and traversing an entire length of, a glass substrate; and
gradient period grating structures located in the glass substrate, wherein the gradient period grating structures traverse along a length of the waveguide and are located around the waveguide.

2. The co-package optics structure of claim 1, wherein the glass substrate has a first refractive index and the waveguide has a second refractive index that is greater than the first refractive index.

3. The co-package optics structure of claim 2, wherein each of the gradient period grating structures has a refractive index that is greater than or equal to the second refractive index, but less than the first refractive index.

4. The co-package optics structure of claim 1, wherein the gradient period grating structures comprise a plurality of groups of period grating structures, wherein each period grating structure within a group of period grating structures is spaced apart by a constant pitch.

5. The co-package optics structure of claim 4, wherein the constant pitch within each group of period grating structures increases from a first end of the waveguide to a second end of the waveguide, wherein the first end represents a starting point of the waveguide in which light enters the waveguide and the second end represents an end point of the waveguide in which light exists the waveguide.

6. The co-package optics structure of claim 5, wherein each group of period grating structures has an effective refractive index that increases from the first end of the waveguide to the second end of the waveguide.

7. The co-package optics structure of claim 1, wherein the gradient period grating structures are located above, below and adjacent to each side of the waveguide.

8. The co-package optics structure of claim 1, further comprises a fiber ferrule attached to the glass substrate.

9. The co-package optics structure of claim 8, wherein the fiber ferrule is substantially aligned to the waveguide.

10. The co-package optics structure of claim 8, wherein the fiber ferrule is mis-aligned to the waveguide.

11. The co-package optics structure of claim 1, wherein the waveguide is a single mode waveguide.

12. The co-package optics structure of claim 1, wherein the glass substrate is composed of an undoped glass material.

13. The co-package optics structure of claim 1, wherein the glass substrate is composed of a doped glass material.

14. The co-package optics structure of claim 1, wherein the glass substrate is composed of fused silica, boro-aluminosilicate, soda lime, Er-Yb co-doped phosphate, Yb-doped phosphate, Yb-doped silicate or Yb doped borosilicate.

15. The co-package optics structure of claim 1, wherein the waveguide is a cylindrical waveguide, and each of the gradient period grating structures is cylindrical.

16. The co-package optics structure of claim 1, wherein each of the gradient period grating structures is spaced apart from the waveguide by a portion of the glass substrate.

17. The co-package optics structure of claim 1, wherein each of the gradient period grating structures and the waveguide is embedded in the glass substrate.

18. A method of forming structure comprising:
forming, using a first laser scanning process, a first row of gradient period grating structures in a glass substrate;
forming, using a continuous laser process, a waveguide in the glass substrate and above the first row of gradient period grating structures; and
forming, using a second laser scanning process, a second row of gradient period grating structures in the glass substrate and above the waveguide.

19. The method of claim 18, further comprising:
forming, using a third laser scanning process, a third row of gradient period grating structures in the glass substrate and adjacent a first side of waveguide; and
forming, using a fourth laser scanning process, a fourth row of gradient period grating structures in the glass substrate and adjacent to a second side of the waveguide, wherein the second side is opposite the first side.

20. The method of claim 18, wherein the continuous laser process, and each of the first laser scanning process and the second laser scanning process increase a refractive index of the glass substrate that is subjected to laser exposure.
